(19) United States
(12) Patent Application Publication
(10) Pub. No.: US 2015/0187025 A1
(43) Pub. Date: Jul. 2, 2015

(54) OPTIMIZATION PLATFORM FOR WATER DISTRIBUTION NETWORKS

(71) Applicant: International Business Machines Corporation, Armonk, NY (US)

(72) Inventors: SEGEV ELIEZER WASSERKRUG, Haifa (IL); ALEXANDER ZADOROJNIY, Haifa (IL)

(73) Assignee: International Business Machines Corporation, Armonk, NY (US)

(21) Appl. No.: 14/145,932

(22) Filed: Jan. 1, 2014

(51) Int. Cl. G06Q 50/06; G06Q 10/06

(52) U.S. Cl. CPC G06Q 50/06; G06Q 10/0631

(57) ABSTRACT

A method comprising using at least one hardware processor for: receiving a hydraulic model of a water distribution network; selecting a headloss model from a headloss models library; mapping components of said hydraulic model to components in a components library; selecting at least one objective from an objectives library; and executing an algorithm for optimization of the water distribution network, to output an optimized algebraic description of the water distribution network, wherein said executing is based on the headloss model, on mapped ones of the components in the components library, and on the at least one objective.

### BACKGROUND

The present invention relates to the field of water distribution network optimization.

Water distribution networks are complex entities, composed of many types of components, such as pipes, valves, pumps and tanks, making their efficient management a significant challenge. The growing worldwide demand for water as well as increasing urbanization renders a growing complexity of water distribution networks. Managing large and complex water distribution networks requires coping with water distribution network matters such as water stagnation management, demand prediction, supply to end consumers according to predefined requirements (pressure, cost, quantity and quality), reduction of Non-Revenue Water (NRW), etc.

One of the most significant matters in water distribution network management, in terms of cost and environmental impact, is reducing Non-Revenue Water (NRW). NRW is water that is input into the network but is not paid for or generating revenue. NRW includes water lost due to leaks, bursts and theft as well as water retention in tanks. According to the Environmental Protection Agency, much of the 880,000 miles of water pipes in the United States has been in service for decades—some for over 100 years—and can be significant source of water loss. The World Bank estimates that worldwide costs from leaks total 14 billion United States Dollars annually.

Whether in developed or developing countries, water networks are frequently managed based on an engineer's knowledge, experience and intuition. As a result, these networks are prone to human errors. In many cases, the management of a network is far from optimal. Thus, water network management supported by advanced data-driven decision support tools can be advantageous.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools and methods which are meant to be exemplary and illustrative, not limiting in scope.

There is provided, in accordance with an embodiment, a method comprising using at least one hardware processor for: receiving a hydraulic model of a water distribution network; receiving a selection of a headloss model from a headloss models library; mapping components of said hydraulic model to components in a components library; receiving a user selection of at least one objective from an objectives library; and executing an algorithm for optimization of the water distribution network, wherein said executing is based on the headloss model, on mapped ones of the components in the components library, and on the at least one objective.

There is further provided, in accordance with an embodiment, a computer program product for water distribution network optimization, the computer program product comprising a non-transitory computer-readable storage medium having program code embodied therewith, the program code executable by at least one hardware processor for: receiving a hydraulic model of a water distribution network; receiving a user selection of a headloss model from a headloss models library; mapping components of said hydraulic model to components in a components library; receiving a user selection of at least one objective from an objectives library; and executing an algorithm for optimization of the water distribution network, wherein said executing is based on the headloss model, on mapped ones of the components in the components library, and on the at least one objective.

In some embodiments, the components library comprises a plurality of components selected from the group consisting of: a valve, a pipe, a pump, a tank and a reservoir; and each of the plurality of components is algebraically-defined.

In some embodiments, the hydraulic model is comprised in an EPANET (Environmental Protection Agency Net) input file.

In some embodiments, the EPANET input file comprises contents selected from the group consisting of: a network topology of the water distribution network, water consumption in the water distribution network, and control rules of the water distribution network.

In some embodiments, the headloss models library comprises one or more headloss models.

In some embodiments, the one or more headloss models are selected from the group consisting of: a Darcy-Weisbach model, a Hazen-Williams model, a Chezy-Manning model and a gravity water line model.

In some embodiments, said mapping is performed automatically.

In some embodiments, said mapping is performed manually, by a user.

In some embodiments, the components in the components library are defined in accordance with object-oriented programming principles,

In some embodiments, the program code is further executable by said at least one hardware processor for instantiating objects for mapped ones of the components in the components library.

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a flow chart of a method for optimization of a water distribution network;

FIG. 2 shows a simplistic, exemplary hydraulic model of a water distribution network; and

FIG. 3 shows a block diagram of different entities acting in execution of the method of FIG. 1.

### DETAILED DESCRIPTION

An optimization platform for water distribution networks is disclosed herein. The platform may be embodied as a computer program product capable of optimizing a hydraulic model of a water distribution network provided as input. The optimization may be in accordance with a user-preferred headloss model, such as the Darcy-Weisbach model, the Hazen-Williams model, the Chezy-Manning model or the gravity water line model, all known in the art.

In order to conduct the optimization, the platform may automatically or manually map (also “associate” or “correlate”) components of the hydraulic model to components pre-provided in a components library of the platform. Components may include, for example, one or more valves, pipes, pumps, tanks and/or reservoirs. Each such component in the components library may be defined algebraically, to enable mathematical computations by the platform. This mathematical computation is performed along with the user-preferred headloss model, which is also mathematical in nature.

A further input to the platform may be one or more objectives defined by the user. The objectives may include, for example, reduction of non-revenue water (NRW), equitable water supply, reduction of energy consumption, reduction of electricity cost, and/or the like—either for one or more specific parts of the network or for its entirety.

Resulting from the optimization is a set of instructions for physical manipulation of one or more components of the pertinent water distribution network, in order to bring the network to its optimal condition or close to it. For example, the instructions may dictate that one or more valves of the network should be manipulated, such as fully or partially opened or closed. The manipulation itself may be performed in situ, manually. In a more advanced alternative, the manipulation may include remote-controlling one or more valves which are equipped with an electromechanical actuator in communication with a control center of the water distribution network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a hardware processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

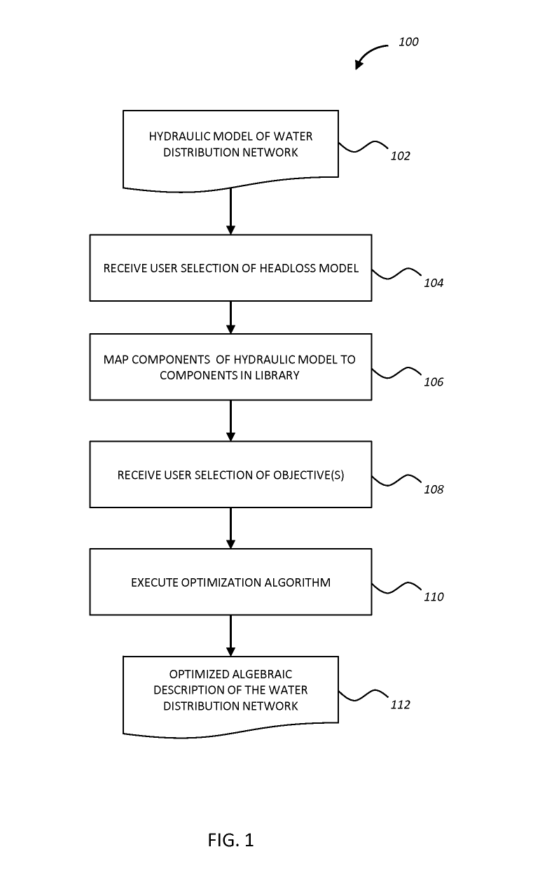

Reference is now made to FIG. 1, which shows a flow chart of a method 100 for optimization of a water distribution network, in accordance with some embodiments. Steps of method 100 need not necessarily be carried out in the order they are shown in the figure or described in the specification. The “platform”, as referred to herein, may be a software implementation of method 100.

In a step 102, a hydraulic model of a water distribution network is received. For example, a user may input a file containing the hydraulic model. Such file formats are known in the art. A prominent example is the EPANET (Environmental Protection Agency Net) input file, often having the extension “.inp”. EPANET is used for simulating, on a computer, complex water distribution networks, such as networks of municipalities, regions or even entire states. An EPANET input file typically include one or more of: a network topology of the water distribution network, water consumption in the water distribution network, and control rules of the water distribution network. For a further discussion of EPANET, see L. A. Rossman, EPANET 2 Users Manual, United States Environmental Protection Agency, EPA/600/R-00-057 (September 2000), available at http://nepis.epa.gov/Adobe/PDF/P1007WWU.pdf, retrieved Oct. 22, 2013.

The hydraulic model may include multiple different components, such as valves, pipes, pumps, tanks and/or reservoirs. The hydraulic model may further include interconnection between at least some of these components.

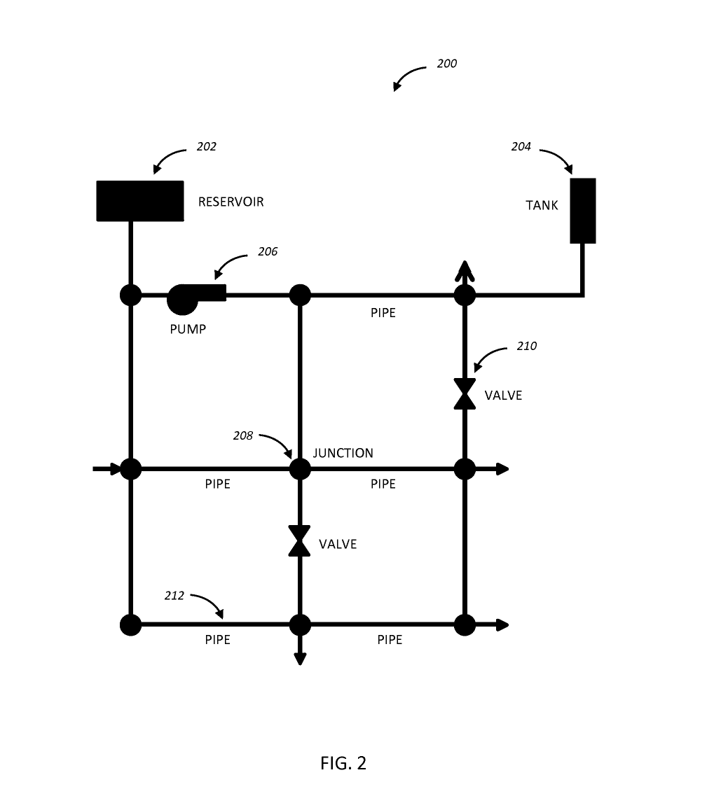

FIG. 2 shows a simplistic, exemplary hydraulic model 200 of a water distribution network. Included in hydraulic model 200 are a reservoir 202, a tank 204, a pump 206, a number of junctions such as junction 208, a number of valves such as valve 210, and a number of pipes such as pipe 212. In reality, a hydraulic model may include a much larger number of components. In addition, each such component may sometimes include various parameters relating thereto, as known in the art.

Reference is made back to FIG. 1. In a step 104, a selection of a desired headloss model may be received, either from a user or automatically, such as based on the pertinent region and the headloss model acceptable in it. To this end, a computerized library of multiple headloss models may be provided. The headloss models library may be provided, for example, in one or more suitable digital files and/or databases, stored on a non-volatile memory. The headloss models may refer, for example, to headloss computation. Headloss, as known in the art, is the loss of energy as a result of friction between the inner walls of a pipe and water flowing inside the pipe.

Various models of headloss are known in the art. Prominent examples include the Darcy-Weisbach model, the Hazen-Williams model, the Chezy-Manning model and the gravity water line model.

The headloss models library may include, for each model contained therein, a mathematical expression of the model. Accordingly, an application of such a headloss model on the hydraulic model received in step 102 may result in an estimation of headloss in various parts of the pertinent water distribution network.

In an alternative implementation, the desired headloss model is not received from the user but is automatically selected by the platform. The automatic selection may be based, for example, on a headloss model defined by and contained within the hydraulic model provided in step 102. Namely, the file containing the hydraulic model, such as the EPANET file, may already define a certain headloss model.

In a step 106, one or more components of the hydraulic model may be mapped to one or more corresponding components in a components library. The components library may be provided, for example, in one or more suitable digital files and/or databases, stored on a non-volatile memory.

The mapping is, essentially, a computerized action of association (also “correlation”) of one or more components of the hydraulic model to one or more components in a components library. For example, a pipe in the hydraulic model may be mapped to a pipe in the components library; a pump in the hydraulic model may be mapped to a pump in the components library; and so on and so forth. It should be noted that these examples are simplistic in nature, for reasons of clarity. In reality, there may exist multiple types of each component class, for example multiple types of pipes. Accordingly, the mapping may include correctly associating each such type with a corresponding type provided in the components library.

The mapping may include, for example, linking between records of multiple database tables which are either stored in the same database or separate ones.

The mapping may be performed either automatically or manually (i.e. by a user). It is also possible to have the mapping performed partly automatically and partly manually. Manual mapping may include prompting the user of the platform to associate each component of the hydraulic model with a component in the components library which seems to the user the most appropriate. Automatic mapping, in contrast, may include automatically analyzing the hydraulic model, determining which components it includes, and searching for corresponding components in the components library. The search may be based, for example, on textual (also “string”) comparison between component names in the hydraulic model and component names in the components library. A match is declared if these names are identical or similar to a degree which was predefined as sufficient.

In some embodiments, one or more of the components in the components library may be algebraically-defined. Namely, the components library may also store an algebraic definition as to one or more of the components. In some embodiments, each and every component is algebraically-defined.

The algebraic definition of the components may enable utilizing these definitions, in a meaningful manner, during computations performed by the present platform. In some embodiments, the algebraic definition includes an algebraic definition of constraints of the pertinent component. These constraints, for example, may relate to physical performance limitations of the component, and/or to human-imposed limitations, which are often lower than the physical performance limitations.

As an example, and for illustrative reasons only, the following is pseudo-code which algebraically defines a basic pipe (also “a pipe class”):

```
subject to {
// Add constraints for inactive pipes
  forall (t in times)
      forall (pipe in inactivePipesArray[t])
        //ct_no_flow_inactive:
        flow_value[pipe] [t]==0; // No flow on inactive pipes
  forall (t in times)
          forall (pipe in checkValvePipes inter
activePipesArray[t])
            flow_value[pipe] [t] >=0;
forall (t in times)
          forall (pipe in activePipesArray[t])
            forall (lk in pipe_links [pipe])
              head[lk.point1_id] [t] −
head[lk.point2_id] [t] − head_loss[pipe] [t]
                + warmStartHLPlus[lk] [t]
warmStartHLMinus[lk] [t]
                  ==0;
    forall (pipe in pipes, t in times)
          sum (lk in pipe_links[pipe]) flow[lk] [t] ==
flow_value[pipe] [t];
}
```

As shown abode, multiple limitations may be defined for the pipe class, in a computer-readable manner. These limitations may dictate, for example, the lack of flow though inactive pipes, unidirectional flow through pipes coupled to check valves, headloss constraints (optionally computed in accordance with the selected headloss model), etc.

A class of components, such as the pipe class, may include one or more sub-classes for algebraically defining more specific limitations of different kinds of pipes. Each such sub-class may inherit the limitations defined for its parent, namely—the class it is dependent upon.

As an example, and for illustrative reasons only, the following is pseudo-code which algebraically defines a certain sub-class of a pipe, termed here a “Hazen-Williams linearized pipe”. Namely, this sub-class includes algebraic limitations of a pipe according to the Hazen-Williams headloss model:

```
subject to {
  forall (t in times)
    forall (pipe in activePipesArray[t])
      head_loss[pipe] [t]
      + hl_dev_plus[pipe] [t] − hl_dev_minus[pipe] [t]
      ==
pipe_resistance[pipe] * (pipeHLSsign[pipe] [t] *pipeHLSfunc[pipe] [t]
+ pipeHLSlopes[pipe] [t] * (flow_value[pipe] [t] −
pipeHLSsign[pipe] [t] *pipeHLSshift[pipe] [t]));
}
```

Similarly, the following is pseudo-code which algebraically defines a certain sub-class of a pipe, termed here a “Darcy-Weisbach linearized pipe”. Namely, this sub-class includes algebraic limitations of a pipe according to the Darcy-Weisbach headloss model:

```
subject to {
  forall (t in times)
    forall (pipe in activePipesArray[t])
      head_loss[pipe] [t]
      + hl_dev_plus[pipe] [t] − hl_dev_minus[pipe] [t]
      ==
pipe_resistanceDW[pipe] [t] * (pipeHLSsignDW[pipe] [t]
*pipeHLSfuncDW[pipe] [t] + pipeHLSlopesDW[pipe] [t] *
(flow_value[pipe] [t] − pipeHLSsignDW[pipe] [t]
*pipeHLSshiftDW[pipe] [t]));
}
```

In some embodiments thereof, the mapping of step 106 may also utilize the headloss model selection made in step 104. Namely, the search for a suitable match for a component of the hydraulic model and a component of the components library may also take into account the headloss model selected by the user.

For example, if the hydraulic model includes a certain pipe, and the headloss model selected in step 104 is the Darcy-Weisbach model, then the search in the components library may be for a sub-class of a pipe defined in accordance with the Darcy-Weisbach headloss model. The same applies to any other headloss model, such as the Hazen-Williams model, the Chezy-Manning model, the gravity water line model and/or any other headloss model known in the art.

In some embodiments thereof, the mapping of step 106 may be followed by an instantiation of multiple objects, one for each component in the hydraulic model. This, in accordance with object-oriented programming principles. As an example, following the mapping, when a certain component in the hydraulic model is mapped to its corresponding component in the components library, a class definition of the component in the components library may be used for instantiating an object of the mapped component. The class definition, as well as any sub-classes thereof (and optionally further lower-nested classes), may optionally be the algebraic definition discussed above.

Put differently, an object-oriented approach to the mapping may include instantiating a plurality of objects for the plurality of components existing in the hydraulic model. This may further facilitate the conduct of computations on these objects.

In a step 108, a user selection of at least one objective from an objectives library may be received. The objectives library may be provided, for example, in one or more suitable digital files and/or databases, stored on a non-volatile memory. The objectives in the objectives library may include, for example, reduction of non-revenue water (NRW), equitable water supply, reduction of energy consumption, reduction of electricity cost, and/or the like—either for one or more specific parts of the network or for its entirety.

For example, the user may define that a certain objective is desired with respect to certain one or more components of the hydraulic model (or objects instantiated based upon them).

The objectives may be defined algebraically, to enable computation. As an example, and for illustrative reasons only, the following is pseudo-code which algebraically defines an exemplary pressure management objective. This exemplary objective is aimed at minimizing headloss and setting flow balance deviation penalties:

```
minimize
  (hl_dev_pen_value * (sum (pipe in pipes, t in times)
  (hl_dev_plus[pipe] [t] + hl_dev_minus[pipe] [t]))
  + flow_dev_pen_value * sum (p in point_ids, t in times)
  (dev_sum_plus[p] [t] + dev_sum_minus[p] [t])
  + hl_dev_pen_value* sum (pump in pumps, t in times)
  (hlPumpsDevPlus[pump] [t]+hlPumpsDevMinus[pump] [t])
  + warmStartHLPenalty * sum(link in links, t in times)
  (warmStartHLPlus[link] [t] + warmStartHLMinus[link] [t])
  + obj_weight*optimizeCriticalPointValues*sumMaxDeviations
  + optimizeCriticalPointValues*sumDeviation
  + deviationOriginalSettingPenalty * sum (valve in PRVsVar)
  distanceSettings[valve];
    ;
subject to
{
  forall (criticalPoint in criticalPoints)
    {
    minPressure[criticalPoint]−minTarget[criticalPoint] −
    aboveMinPressure[criticalPoint] +
    belowMinPressure[criticalPoint]==0;
    maxPressure[criticalPoint]−maxTarget[criticalPoint] −
    aboveMaxPressure[criticalPoint] +
    belowMaxPressure[criticalPoint]==0;
    avgPressure[criticalPoint]−avgTarget[criticalPoint] −
    aboveAvgPressure[criticalPoint] +
    belowAvgPressure[criticalPoint]==0;
  }
```

As another example, and for illustrative reasons only, the following is pseudo-code which algebraically defines another exemplary pressure management objective. This exemplary objective is aimed at minimizing overall pressure in a water distribution network, given some lower bounds pertaining to pressure:

```
minimize
  hl_dev_pen_value * sum (pipe in pipes, t in times)
  (hl_dev_plus[pipe] [t] + hl_dev_minus[pipe] [t])
  + flow_dev_pen_value * sum (p in point_ids, t in times)
  (dev_sum_plus[p] [t] + dev_sum_minus[p] [t])
  + hl_dev_pen_value* sum (pump in pumps, t in times)
  (hlPumpsDevPlus[pump] [t]+hlPumpsDevMinus[pump] [t])
  + warmStartHLPenalty * sum(link in links, t in times)
  (warmStartHLPlus[link] [t] + warmStartHLMinus[link] [t])
  + obj_weight*optimizeCriticalPointValues*sum (p in point_ids
  diff (source_ids union fixed_head_nodes), t in times)
  press [p] [t]
  + deviationOriginalSettingPenalty * sum (valve in PRVsVar)
  distanceSettings[valve];
    ;
subject to
{
  forall (p in point_ids diff (source_ids union
  fixed_head_nodes), t in times)
  press[p] [t] >= lowerBoundPressure_prob +
  lowerBoundPressure_delta;
}
```

In a step 110, an algorithm for optimization of the water distribution network may be executed. This execution may be based, for example, on the headloss model selected in step 104, on mapped ones of the components in the components library (or objects instantiated therefrom) of step 106, and/or on at least one of the objectives selected in step 108. Namely, these bases for execution may serve as input for the optimization algorithm.

Various optimization algorithms for water distribution networks are known in the art and may be used in step 110. An example of a suitable algorithm is the method for approximating solutions for optimized management of a liquid distribution network, discussed in U.S. patent application Ser. No. 13/905,151 to Sambur et al.

Another exemplary, suitable algorithm is discussed in J. Burgschweiger, B. Gnadig, and M. C. Steinbach, Optimization Models for Operative Planning in Drinking Water Networks, in Konrad-Zuse-Zentrum fur Informationstechnik Berlin, report no. 04-48 (December 2004).

In a step 112, the execution of the optimization algorithm may result in an optimized algebraic description of the water distribution network. This algebraic description may be solved by a suitable solver, embodied as a mathematical software product. In some scenarios, a linear solver may be suitable. In some other scenarios, a non-linear solver may be fit. Many such solvers are known in the art, and may be utilized, at the discretion of the user, for solving the optimized algebraic description of the water distribution network.

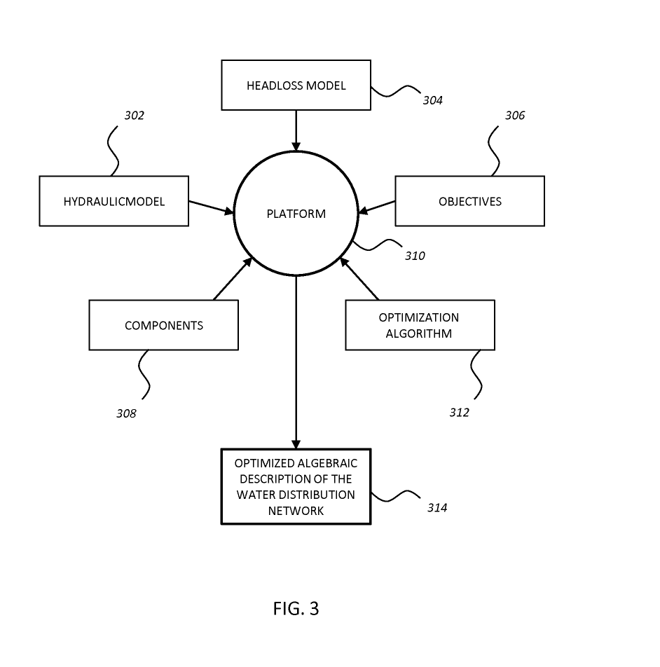

Reference is now made to FIG. 3, which shows a block diagram of the different entities acting in execution of method 100 of FIG. 1.

A platform 310 may be a generic software application, configured to execute some or all of the steps of method 100 of FIG. 1. The term “generic” means that platform 310 may be a modular system which may be employed by different end users for optimizing different physical water distribution networks. For example, platform 310 may be provided as an off-the-shelf software application, usable by entities such as municipal water departments, regional water departments, state water departments, etc.

Platform 310 may receive as input and/or include a hydraulic model of a water distribution network 302, a headloss model 304, one or more objectives 306, a library of components 308 and/or an optimization algorithm 312.

Resulting from the operation of platform 310, or, more specifically, from the execution of optimization algorithm 312, is the output of an optimized algebraic description of the water distribution network 314.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising using at least one hardware processor for:
receiving a hydraulic model of a water distribution network;
receiving a selection of a headloss model from a headloss models library;
mapping components of said hydraulic model to components in a components library;
receiving a user selection of at least one objective from an objectives library; and
executing an algorithm for optimization of the water distribution network, to output an optimized algebraic description of the water distribution network, wherein said executing is based on the headloss model, on mapped ones of the components in the components library, and on the at least one objective.

2. The method according to claim 1, wherein:
the components library comprises a plurality of components selected from the group consisting of: a valve, a pipe, a pump, a tank and a reservoir; and
each of the plurality of components is algebraically-defined.

3. The method according to claim 1, wherein the hydraulic model is comprised in an EPANET (Environmental Protection Agency Net) input file.

4. The method according to claim 3, wherein the EPANET input file comprises contents selected from the group consisting of: a network topology of the water distribution network, water consumption in the water distribution network, and control rules of the water distribution network.

5. The method according to claim 1, wherein the headloss models library comprises one or more headloss models.

6. The method according to claim 5, wherein the one or more hydraulic head losses are selected from the group consisting of: a Darcy-Weisbach model, a Hazen-Williams model, a Chezy-Manning model and a gravity water line model.

7. The method according to claim 1, wherein said mapping is performed automatically.

8. The method according to claim 1, wherein said mapping is performed manually, by a user.

9. The method according to claim 1, wherein the components in the components library are defined in accordance with object-oriented programming principles,

10. The method according to claim 9, method further comprising using said at least one hardware processor for instantiating objects for mapped ones of the components in the components library.

11. A computer program product for water distribution network optimization, the computer program product comprising a non-transitory computer-readable storage medium having program code embodied therewith, the program code executable by at least one hardware processor for:
receiving a hydraulic model of a water distribution network;
receiving a selection of a headloss model from a headloss models library;
mapping components of said hydraulic model to components in a components library;
receiving a user selection of at least one objective from an objectives library; and
executing an algorithm for optimization of the water distribution network, to output an optimized algebraic description of the water distribution network, wherein said executing is based on the headloss model, on mapped ones of the components in the components library, and on the at least one objective.

12. The computer program product according to claim 11, wherein:
the components library comprises a plurality of components selected from the group consisting of: a valve, a pipe, a pump, a tank and a reservoir; and
each of the plurality of components is algebraically-defined.

13. The computer program product according to claim 11, wherein the hydraulic model is comprised in an EPANET (Environmental Protection Agency Net) input file.

14. The computer program product according to claim 12, wherein the EPANET input file comprises contents selected from the group consisting of: a network topology of the water distribution network, water consumption in the water distribution network, and control rules of the water distribution network.

15. The computer program product according to claim 11, wherein the headloss models library comprises one or more models of headloss.

16. The computer program product according to claim 15, wherein the one or more head loss models are selected from the group consisting of: a Darcy-Weisbach model, a Hazen-Williams model, a Chezy-Manning model and a gravity water line model.

17. The computer program product according to claim 11, wherein said mapping is performed automatically.

18. The computer program product according to claim 11, wherein said mapping is performed manually, by a user.

19. The computer program product according to claim 11, wherein the components in the components library are defined in accordance with object-oriented programming principles,

20. The computer program product according to claim 19, wherein the program code is further executable by said at least one hardware processor for instantiating objects for mapped ones of the components in the components library.
